(19) United States
(12) Patent Application Publication
(10) Pub. No.: US 2023/0231289 A1
(43) Pub. Date: Jul. 20, 2023

(54) Battery Cell Having an Electrical Fuse

(71) Applicant: Bayerische Motoren Werke Aktiengesellschaft, Muenchen (DE)

(72) Inventors: Sebastian SCHARNER, Tuerkenfeld (DE); Moritz SCHIEDER, Vaesteras (SE); Benjamin WEBER, Muenchen (DE)

(21) Appl. No.: 18/008,480

(22) PCT Filed: Jul. 7, 2021
(86) PCT No.: PCT/EP2021/068766

§ 371 Date: Dec. 6, 2022

(30) Foreign Application Priority Data
Jul. 16, 2020 (DE) 10 2020 118 843.9

(51) Int. Cl. H01M 50/583; H01M 10/0525

(52) U.S. Cl. CPC H01M 50/583; H01M 10/0525

(57) ABSTRACT

A battery cell has an electrical fuse. The electric fuse is a fusible link which is arranged on a terminal on an outside of a housing of the battery cell. The fusible link is covered by a polymer.

### BACKGROUND AND SUMMARY

The invention relates to a battery cell having an electrical fuse, in particular a battery cell for a high-voltage battery.

Electrically powered motor vehicles such as electric vehicles, hybrid vehicles or plug-in hybrid vehicles employ high-voltage batteries which typically comprise one or more battery modules, each comprising a plurality of battery cells. Due to the achievable high energy density, motor vehicles especially employ lithium-ion batteries. Here and hereinbelow, the term “lithium-ion battery” is used synonymously with all designations for lithium-containing galvanic elements and cells commonly used in the prior art, for example lithium battery cell, lithium battery, lithium-ion battery cell, lithium cell, lithium-ion cell, lithium polymer cell, lithium polymer battery and lithium-ion accumulator. Rechargeable batteries (secondary batteries) are especially included. The terms “battery” and “electrochemical cell” are also used synonymously with the term “lithium-ion battery” and “lithium-ion battery cell”. The lithium-ion battery may also be a solid-state battery, for example a ceramic or polymer-based solid-state battery.

In the case of a mechanical impact onto the battery cell which may bring about for example a deformation and/or penetration of a sharp object into the battery cell, there may be a risk of an electrical shorting of the electrodes. Exothermic electrode reactions, brought about for example due to a shorting of the electrodes, can liberate heat which can result in overheating of the battery cell. This can result in thermal runaway of the battery cell. In a battery module comprising a plurality of battery cells, the thermal runaway of one battery cell can result in spreading of the overheating to adjacent battery cells, thus presenting a risk of damage to the entire battery module or even the entire high-voltage battery if this is not prevented by suitable safety measures.

Published specification DE 10 2013 204 341 A1 describes a safety element for a battery cell. The battery cell contains a fuse arranged inside the battery cell housing between the positive terminal and the current collector assigned to the positive terminal.

It is an object of the present invention to provide an improved battery cell having an electrical fuse, wherein the battery cell features a further increase in safety and a reduced risk of thermal runaway.

This object is achieved by a battery cell according to the independent claim. Advantageous embodiments and developments of the invention are apparent from the dependent claims.

In one embodiment of the invention, the battery cell has an electrical fuse, wherein the electrical fuse is a fuse arranged on a terminal on an outer surface of the housing of the battery cell. The fuse is preferably formed from a metal or a metal alloy. The fuse preferably comprises or consists of aluminum. The fuse is advantageously covered by a polymer.

The proposed arrangement of the fuse on a terminal on an outer surface of the housing results in an advantageous spatial separation of the electrochemically active elements of the battery cell from the fuse. The terminal at which the fuse is arranged may, in particular, be arranged on a lid of the housing. In this case the fuse is separated from the electrochemically active elements of the battery cell by the material of the housing.

The covering of the fuse with a polymer prevents the occurrence of an electrical arc upon melting of the fuse. Furthermore, this protects the fuse from mechanical damage and corrosion while simultaneously increasing mechanical stability. The polymer may be an epoxy resin for example.

The battery cell is preferably a prismatic battery cell. The housing of the battery cell may have for example a rectangular footprint and be substantially cuboidal. The housing may comprise for example a floor wall, side walls and a lid. Prismatic battery cells are advantageously easy to stack and assemble into a battery module. The housing of the battery cell may comprise a metal or a metal alloy, for example aluminum. It is possible for the housing to be at least partially provided with an electrically insulating coating.

The terminals of the battery cell are arranged on the lid of the housing for example. The battery cell comprises in particular a positive terminal and a negative terminal. The terminals form the outer electrical connections of the battery cell and are each connected to a current collector of an electrode. The fuse protects the battery cell from excessive currents, in particular in the case of a shorting of the electrodes. Such a shorting of the electrodes may be the result for example of a deformation of the housing or the penetration of a sharp object into the housing, for instance during a crash.

The invention is in particular based on the following considerations: the melting of a fuse in the case of a short entails the risk that the liquefied material of the fuse is sprayed into the environment of the fuse. In the case of a fuse made of aluminum, molten aluminum may be sprayed for example. In the conventional arrangement of the fuse inside the battery cell housing there is a risk that the sprayed hot material reacts with the electrochemically active materials inside the battery cell, for example with the electrolytes or the materials of the electrodes. Exothermic chemical reactions promote the risk of overheating of the battery cell up to and including the thermal runaway. The proposed arrangement of the fuse on a terminal on an outer surface of the housing avoids spraying of the material of the fuse inside the housing and the risk of thermal runaway is reduced, thus increasing safety.

The arrangement of the fuse on the outer surface of the battery cell housing also reduces the evolution of heat inside the battery cell housing which occurs even during normal operation, for example during rapid charging, as a result of the Joule heat occurring due to the resistance of the fuse. This makes it possible to prevent a battery management system (BMS) from effecting a performance restriction for the battery cell due to a detected excessive temperature in the battery cell housing.

In one embodiment, the terminal in which the fuse is arranged is the positive terminal of the battery cell. In this case the terminal is connected to the positive electrode (cathode during discharging operation). The arrangement at the positive terminal has the advantage that aluminum, which has a lower melting point than the material copper typically used at the negative terminal, can be used as the material for the fuse.

In one embodiment, the polymer with which the fuse is covered comprises a filler for improving heat removal from the fuse. Particularly suitable fillers for improving heat removal are Al(OH)₃ or Al₂O₃.

Alternatively or in addition, the polymer advantageously contains a filler that is an oxidant. A filler suitable as an oxidant is for example ammonium perchlorate (NH₄ClO₄). The oxidant can advantageously react with the material of the fuse to afford an oxide and in this way effect separation of the current flow. In the case of a fuse made of aluminum and ammonium perchlorate as oxidant, nonconductive aluminum oxide (Al₂O₃) is formed for example.

In one embodiment, the positive terminal is electrically insulated from the housing. This advantageously makes it possible to prevent electrochemical processes from forming lithium and/or copper deposits, which could result in internal shorting of the battery cell, in the cell interior. This further reduces the risk of thermal runaway of the battery cell.

In an alternative embodiment, a seal which comprises an electrically conductive plastic, in particular a plastic having only a low electrical conductivity, is arranged between the positive terminal and the housing. In this case the housing is electrically connected to the positive terminal. In this case the housing has the potential of the cathode. This embodiment may be preferred for production reasons.

Further proposed are a lithium-ion battery comprising a plurality of the battery cells described herein and a motor vehicle comprising such a lithium-ion battery. The battery cell described herein may, on account of improved safety, advantageously be employed in a lithium-ion battery which may in particular be employed as a traction battery in an electrically powered motor vehicle.

A preferred exemplary embodiment of the invention is described below with reference to the figures. Further details, preferred embodiments and developments of the invention are apparent therefrom.

### BRIEF DESCRIPTION OF THE DRAWINGS

FIG. 1 is a schematic perspective representation of a housing of the battery cell according to an embodiment;

FIG. 2A is a schematic detail view of the region of the positive terminal in an exploded representation; and

FIG. 2B is a schematic detail view of the region of the positive terminal of the battery cell in cross section.

Identical or identically acting constituents are each provided with identical reference numerals in the figures. The constituents shown and the size ratios of the constituents relative to one another are not to scale.

### DETAILED DESCRIPTION OF THE DRAWINGS

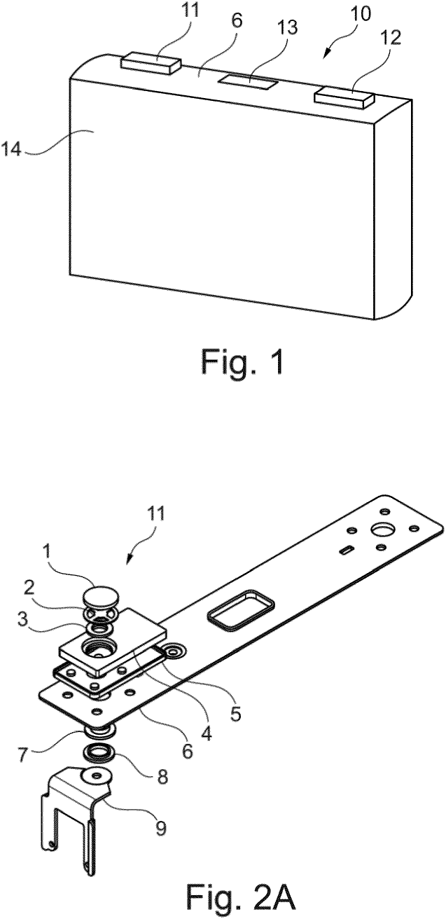

The battery cell 10 shown in schematic form in FIG. 1 is, in the exemplary embodiment shown here, a prismatic battery cell 10. The battery cell 10 comprises a housing 14 which forms a mechanically solid shell for the cell layers of the battery cell 10 arranged therein. In the battery cell 10, the cell layers may be in the form of cell stacks or wound cells for example. In the exemplary embodiment, the housing 14 has a rectangular footprint and is substantially cuboidal. The housing 14 may be formed from a metal or a metal alloy, preferably from aluminum. It is possible for the housing 14 to comprise an electrically insulating coating at least in regions. The battery cell 10 comprises a positive terminal 11 and a negative terminal 12, wherein the terminals 11, 12 are arranged on a lid 6 of the housing 14 for example. The terminals 11, 12 are provided for electrical contracting of the poles of the cell stack or wound cell of the battery cell 10. FIG. 1 further shows a cover 13 arranged on the lid 6 of the housing, which cover 13 is arranged for example in the region between the electrical terminals 11, 12. An overpressure safety apparatus such as for example a rupture membrane may be arranged under the cover 13.

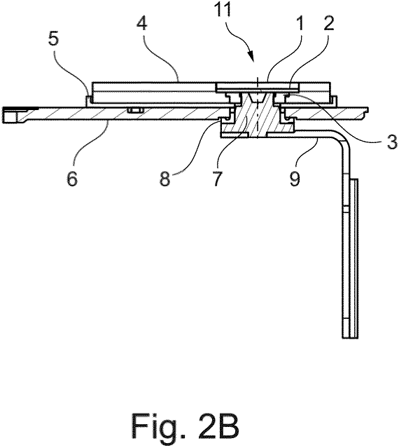

FIGS. 2A and 2B show details in the region of the positive terminal 11 in an exploded representation and in a cross section. The positive terminal 11 comprises an electrical connection plate 4 which is electrically connected to a current collector 9 of the positive pole (cathode) of the battery cell by a rivet 7 and a fuse 2. The mechanical connections may be produced for example by laser welding. An electrically insulating plate 5 is arranged between the electrical connection plate 4 and the lid 6 of the housing 14. An annular insulator 3, which prevents direct contact between the current-conducting rivet 7 and the connection plate 4, is arranged in a recess of the connection plate 4. The current flow from the current collector 9 to the connection plate 4 is effected via the rivet 7 and the fuse 2 arranged thereabove. The fuse 2 preferably comprises or consists of aluminum.

The fuse 2 has a safety function in the battery cell 10. When the fuse melts, for example due to excessive currents in the case of a shorting of the battery cell 10, the electrical connection between the current collector 9 and the connection plate 4 of the positive terminal 11 is interrupted.

In the battery cell 10, the fuse 2 is arranged on the positive terminal 11 outside the housing 14. This prevents the material of the fuse 2, for example aluminum, from being distributed in the battery cell and reacting with the materials in the battery cell in the event of melting. This reduces the risk of thermal runaway of the battery cell.

The fuse 2 is advantageously covered by a polymer 1, for example an epoxy resin, on an outer surface facing away from the housing. The polymer 1 may be applied to the fuse 2 by a spraying process for example. The polymer 1 prevents formation of an electrical arc, in particular in the case of enrichment with an oxidant by forming nonconductive material, upon melting of the fuse 2. In addition, the polymer 1 protects the fuse 2 from mechanical damage and corrosion and increases mechanical stability.

To improve heat removal, the polymer 1 may be admixed with at least one filler (for example Al(OH)₃ or Al₂O₃). It is further advantageous when the filler contains oxidant (for example ammonium perchlorate (NH₄ClO₄)). In this case the oxidant can react with the liquefied aluminum of the fuse 2 to afford nonconductive aluminum oxide (Al₂O₃).

In a preferred embodiment, the lid 6 of the housing 14 is electrically insulated from the connection plate 4 of the positive terminal 11. This may be achieved when a seal 8, arranged between the electrically conductive rivet 7 and the housing lid 6, comprises an electrically insulating plastic. This avoids the possibility of failure of a resistor, which in conventional battery cells connects the housing with the positive terminal, in the case of an excessive current. If a conventional battery cell is serially connected to further battery cells in a battery module, a failure of the resistor through sudden interruption of the contact between the positive terminal and the housing can result in a risk of the voltage of at least one adjacent battery cell being applied to the battery cell and bringing about a polarity inversion of the affected battery cell. In this case a negative potential would be applied to the housing and could bring about unwanted chemical reactions such as for example deposition of lithium or copper in the battery cell. This could result in an internal shorting of the battery cell. The insulation of the positive terminal 11 from the housing 14 proposed here, in particular via the seal 8, makes it possible to reduce this risk.

Although the invention has been illustrated and described in detail using exemplary embodiments the invention is not limited by the exemplary embodiments. On the contrary, other variations of the invention may be derived therefrom without departing from the scope of protection of the invention defined by the claims.

List of reference numerals

| | |
|---|---|
| 1 | Polymer |
| 2 | Fuse |
| 3 | Insulation |
| 4 | Electrically conductive connection plate |
| 5 | Insulating plate |
| 6 | Lid |
| 7 | Electrically conductive rivet |
| 8 | Seal |
| 9 | Current collector |
| 10 | Battery cell |
| 11 | Positive terminal |
| 12 | Negative terminal |
| 13 | Cover for rupture membrane |
| 14 | Housing |

1-10. (canceled)

11. A battery cell, comprising:
an electrical fuse;
a terminal on an outer surface of a housing of the battery cell, wherein
the electrical fuse is arranged on the terminal, and
the electrical fuse is covered by a polymer.

12. The battery cell according to claim 11, wherein the terminal is a positive terminal.

13. The battery cell according to claim 11, wherein the polymer comprises at least one filler that improves heat removal.

14. The battery cell according to claim 13, wherein the filler comprises Al(OH)₃ or Al₂O₃.

15. The battery cell according to claim 11, wherein the polymer contains at least one filler that is an oxidant.

16. The battery cell according to claim 15, wherein the filler is ammonium perchlorate.

17. The battery cell according to claim 11, wherein the terminal is electrically insulated from the housing.

18. The battery cell according to claim 11, further comprising:
a seal comprising an electrically conductive plastic, the seal being arranged between the terminal and the housing.

19. A lithium-ion battery, comprising:
a plurality of battery cells, each battery cell comprising:
an electrical fuse;
a terminal on an outer surface of a housing of the battery cell, wherein
the electrical fuse is arranged on the terminal, and
the electrical fuse is covered by a polymer.

20. A motor vehicle comprising a lithium-ion battery according to claim 19.
